(19) United States
(12) Patent Application Publication
(10) Pub. No.: US 2025/0196785 A1
(43) Pub. Date: Jun. 19, 2025

(54) INFORMATION PROCESSING APPARATUS

(71) Applicant: TOYOTA JIDOSHA KABUSHIKI KAISHA, Toyota-shi (JP)

(72) Inventors: Yuki TATSUMOTO, Seto-shi (JP); Josuke YAMANE, Nagoya-shi (JP); Hirotaka NOGAMI, Nisshin-shi (JP); Kazuya NISHIMURA, Anjo-shi (JP); Takumi FUKUNAGA, Iwakura-shi (JP)

(73) Assignee: TOYOTA JIDOSHA KABUSHIKI KAISHA, Toyota-shi (JP)

(21) Appl. No.: 18/963,484

(22) Filed: Nov. 28, 2024

(30) Foreign Application Priority Data
Dec. 15, 2023 (JP) 2023-212405

(51) Int. Cl. B60R 16/023; B60R 1/24

(52) U.S. Cl. CPC B60R 16/023; B60R 1/24; B60R 2300/50

(57) ABSTRACT

An information processing apparatus to be mounted in a vehicle includes an imager configured to capture an image of scenery outside the vehicle, an input interface configured to accept a capturing operation by a user, and a controller configured to control the imager to capture a still image in a case in which a first capturing operation is detected and capture a moving image in a case in which a second capturing operation is detected, the first capturing operation being a short press operation and the second capturing operation is a long press operation.

### CROSS-REFERENCE TO RELATED APPLICATION

This application claims priority to Japanese Patent Application No. 2023-212405 filed on Dec. 15, 2023, the entire contents of which are incorporated herein by reference.

### TECHNICAL FIELD

The present disclosure relates to an information processing apparatus.

### BACKGROUND

Capturing an image of the front of a vehicle with an in-vehicle camera of a driving recorder in response to an operation to a steering switch is disclosed. For example, see Patent Literature (PTL) 1.

### CITATION LIST

### Patent Literature

PTL 1: JP 2013-143723 A

### SUMMARY

While conventional driving recorders can capture not only moving images but still images, switching between moving image and still image capture modes can only be done from the setting screen, which is not always convenient. Thus, there is room for improvement with respect to technology for controlling an imager of a vehicle.

It would be helpful to improve technology for controlling an imager of a vehicle.

An information processing apparatus according to an embodiment of the present disclosure is an information processing apparatus to be mounted in a vehicle, the information processing apparatus including:
an imager configured to capture an image of scenery outside the vehicle;
an input interface configured to accept a capturing operation by a user; and
a controller configured to control the imager to capture a still image in a case in which a first capturing operation is detected and capture a moving image in a case in which a second capturing operation is detected, the first capturing operation being a short press operation and the second capturing operation is a long press operation.

According to an embodiment of the present disclosure, technology for controlling an imager of a vehicle is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of an information processing apparatus;

FIG. 3 is a flowchart illustrating operations of the information processing apparatus;

FIG. 4 is a diagram illustrating an example of a user interface; and

FIG. 5 is a diagram illustrating another example of the user interface.

### DETAILED DESCRIPTION

Hereinafter, an embodiment of the present disclosure will be described.

### Outline of Embodiment

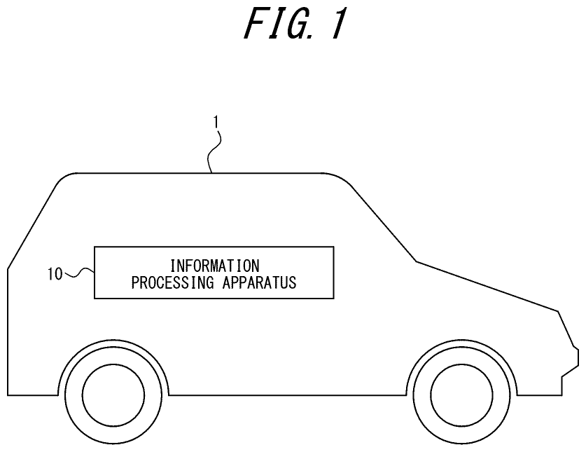

An outline of technology according to an embodiment of the present disclosure will be described with reference to FIG. 1. The technology according to the embodiment of the present disclosure includes a vehicle 1 and an information processing apparatus 10 mounted in the vehicle 1.

The vehicle 1 is an automobile, for example, but is not limited to this and may be any appropriate vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these.

The information processing apparatus 10 is any apparatus used by an occupant of the vehicle 1. For example, a dedicated in-vehicle device such as a driving recorder can be employed as the information processing apparatus 10.

First, an outline of the present embodiment will be described, and details thereof will be described later. The information processing apparatus 10 captures images of the scenery outside the vehicle by an imager. The information processing apparatus 10 also accepts capturing operations by a user. The information processing apparatus 10 captures a still image using the imager in a case in which a first capturing operation is detected and captures a moving image using the imager in a case in which a second capturing operation is detected. Here, the first capturing operation is a short press operation, and the second capturing operation is a long press operation.

Thus, according to the present embodiment, technology for controlling the imager of the vehicle is improved in that the first capturing operation (short press operation) or the second capturing operation (long press operation) can be used to switch between the still image and the moving image by the imager.

### (Configuration of Information Processing Apparatus)

Next, configurations of the information processing apparatus 10 will be described in detail. The information processing apparatus 10 is any apparatus used by the user.

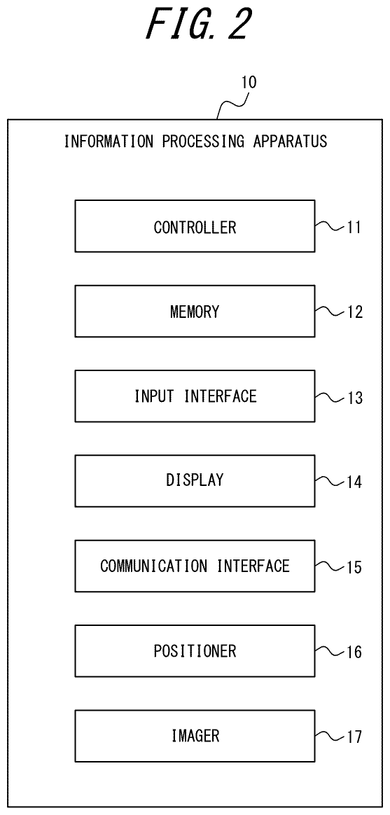

As illustrated in FIG. 2, the information processing apparatus 10 includes a controller 11, a memory 12, an input interface 13, a display 14, a communication interface 15, a positioner 16, and an imager 17.

The controller 11 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 11 executes processes related to operations of the information processing apparatus 10 while controlling components of the information processing apparatus 10.

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM).

The ROM is, for example, electrically erasable programmable read only memory (EEPROM). The memory 12 functions as, for example, a main memory, an auxiliary memory, or a cache memory. The memory 12 stores data to be used in the operations of the information processing apparatus 10 and data obtained by the operations of the information processing apparatus 10.

The input interface 13 includes at least one interface for input. The interface for input is, for example, a physical key, a capacitive key, a pointing device, or a touch screen integrally provided with a display. The interface for input may be, for example, a sound sensor that accepts audio input, a camera that accepts gesture input, or the like. The input interface 13 accepts an operation for inputting data to be used for the operations of the information processing apparatus 10. The input interface 13 may be connected to the information processing apparatus 10 as an external input device, instead of being included in the information processing apparatus 10. As a connection method, for example, any method such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The display 14 includes at least one interface for display output. The interface for display output is, for example, a display that displays the scenery in front of the vehicle 1 or the like. The display is, for example, a liquid crystal display (LCD) or an organic electro luminescent (EL) display. The display 14 displays and outputs data obtained by the operations of the information processing apparatus 10. The display 14 may be connected to the information processing apparatus 10 as an external output device, instead of being included in the information processing apparatus 10. As the connection method, any technology such as USB, HDMI®, or Bluetooth® can be used.

The communication interface 15 includes a communication interface for connection to a network. For example, the communication interface 15 may be equipped with a communication interface that connects to CAN. The communication interface for connection to the network is compliant with mobile communication standards or the like, but is not limited to these and may be compliant with any communication standard. In the present embodiment, the information processing apparatus 10 that one mobile object has is wirelessly connected to the information processing apparatus that another mobile object has via the communication interface 15 and the network. The communication interface 15 receives data to be used for the operations of the information processing apparatus 10, and transmits data obtained by the operations of the information processing apparatus 10.

The positioner 16 includes one or more apparatuses that acquire positional information for the information processing apparatus 10 (i.e., positional information for the vehicle 1). Specifically, the positioner 16 includes, for example, a receiver compliant with GPS, but is not limited to this example and may include a receiver compliant with any appropriate satellite positioning system.

The imager 17 includes an in-vehicle camera that generates still and moving images (hereinafter also collectively referred to as images), which are captured images of the outside scenery in front of the vehicle 1. The in-vehicle camera included in the imager 17 may be a monocular camera or a stereo camera. The imager 17 is installed in the vehicle 1 so that the imager 17 can capture images of the outside scenery in front of the vehicle 1. The imager 17 captures an image of the outside scenery in front of the vehicle 1, thereby enabling the controller 11 to display the image of the front on the display 14.

The functions of the information processing apparatus 10 may be implemented by a processor corresponding to the information processing apparatus 10 executing a program according to the present embodiment. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

Some or all of the functions of the information processing apparatus 10 may be realized by a dedicated circuit corresponding to the controller 11. That is, some or all of the functions of the information processing apparatus 10 may be realized by hardware.

### (Operations of Information Processing Apparatus)

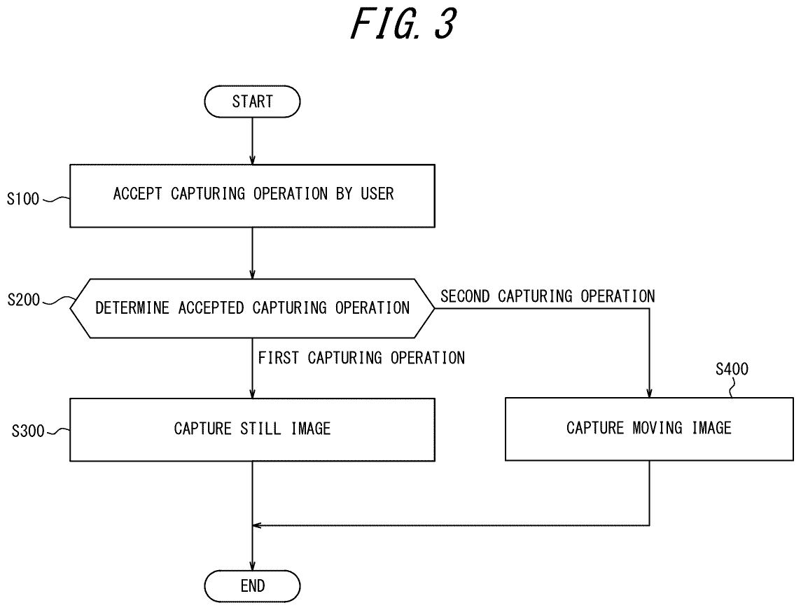

The operations of the information processing apparatus 10 according to the present embodiment will be described with reference to FIG. 3.

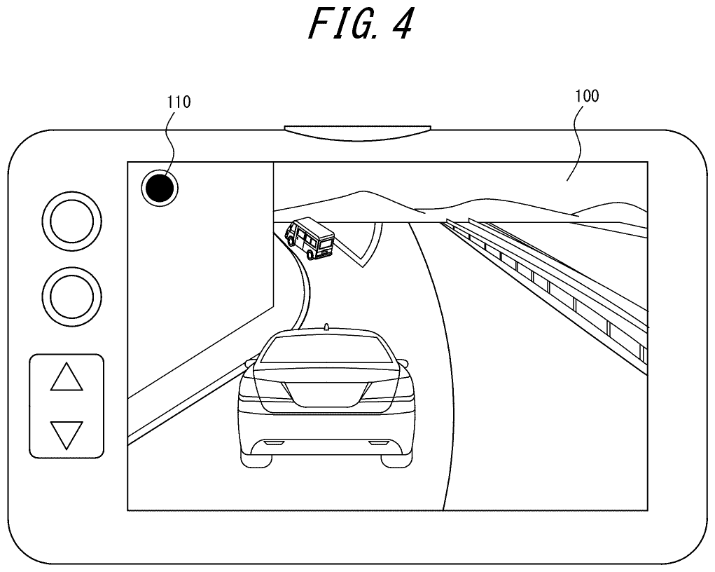

Step S100: The controller 11 of the information processing apparatus 10 accepts a capturing operation by the user. Any method can be employed to accept the capturing operation. For example, the capturing operation may be an operation on the shutter button object included in the user interface displayed by the display 14. In this case, the controller 11 may detect the operation of such shutter button objects and accept the capturing operation. For example, the capturing operation may be an operation of a switch on the steering wheel, and the controller 11 may accept the capturing operation based on the operation of such a switch on the steering wheel. The following is an example of accepting a capturing operation based on the operation of the shutter button object. FIG. 4 illustrates an example of a user interface 100 displayed by the display 14. As illustrated in FIG. 4, the user interface 100 includes a shutter button object 110. Such object 110 is used to accept the capturing operation.

Step S200: The controller 11 determines the accepted capturing operation. Specifically, the controller 11 determines whether the accepted capturing operation is a first capturing operation or a second capturing operation. Here, the first capturing operation is a short press operation. The second capturing operation is a long press operation. In other words, the first capturing operation is a pressing, tapping, or clicking operation that takes less than a predetermined time. The second capturing operation is a pressing, tapping, or clicking operation for a predetermined period of time or longer. In a case in which the first capturing operation is detected, the process proceeds to step S300. In a case in which the second capturing operation is detected, the process proceeds to step S400.

Step S300: In a case in which the first capturing operation is detected in step S200, the controller 11 captures a still image using the imager 17.

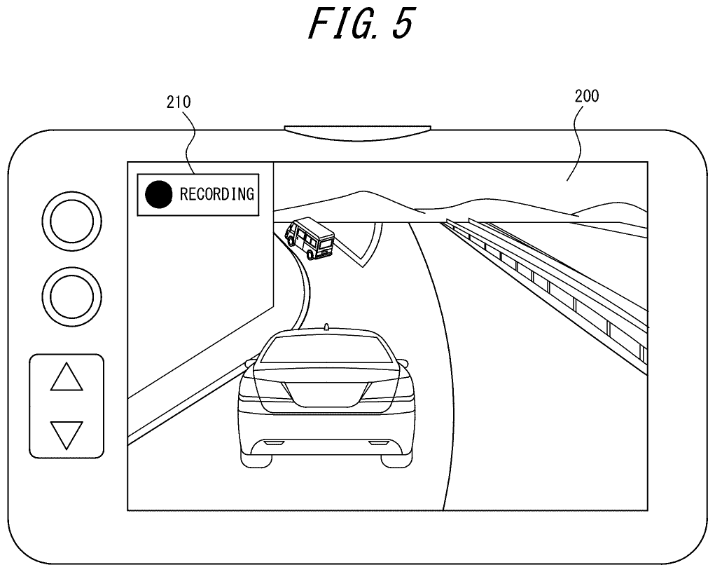

Step S400: In a case in which the second capturing operation is detected in step S200, the controller 11 captures a moving image using the imager 17. FIG. 5 illustrates a user interface 200 displayed by the display 14 when the moving image is captured. As illustrated in FIG. 5, the user interface 200 includes an icon 210 indicating that the moving image is being captured. In other words, the icons in the user interface are switched to indicate that switching between the moving image and the still image has been done through the second capturing operation (in this case, a long press operation on the object 110).

As described above, according to the information processing apparatus 10 according to the present embodiment, the technology for controlling the imager 17 of the vehicle is improved in that the first capturing operation (short press operation) or the second capturing operation (long press operation) can be used to switch between the still image and the moving image by the imager 17. In addition, the user can switch between moving image and still image capture modes with a simple operation, which improves convenience.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, the controller 11 may change a setting of the imager 17 according to a vehicle speed. The setting of the imager 17 includes a shutter speed, and the controller 11 may increase the shutter speed as the vehicle speed increases. The setting may also include a frame rate. In this case, the controller 11 may increase the frame rate as the vehicle speed increases. In this way, the moving image and the still image captured by the imager 17 can be optimized for the speed.

The controller 11 may also determine whether to accept the capturing operation based on the positional information for the vehicle 1. For example, the controller 11 may allow the acceptance of the capturing operation when the positional information for the vehicle 1 is in the predetermined area. The predetermined area may be, for example, a landscaped area.

1. An information processing apparatus to be mounted in a vehicle, the information processing apparatus comprising:
an imager configured to capture an image of scenery outside the vehicle;
an input interface configured to accept a capturing operation by a user; and
a controller configured to control the imager to capture a still image in a case in which a first capturing operation is detected and capture a moving image in a case in which a second capturing operation is detected, the first capturing operation being a short press operation and the second capturing operation is a long press operation.

2. The information processing apparatus according to claim 1, wherein the controller is configured to change a setting of the imager according to a vehicle speed.

3. The information processing apparatus according to claim 2, wherein the setting includes a shutter speed, and the controller is configured to increase the shutter speed as the vehicle speed increases.

4. The information processing apparatus according to claim 2, wherein the setting includes a frame rate, and the controller is configured to increase the frame rate as the vehicle speed increases.

5. The information processing apparatus according to claim 1, wherein the controller is configured to determine whether to accept the capturing operation based on positional information for the vehicle.
